(19) United States
(12) Patent Application Publication
(10) Pub. No.: US 2019/0137788 A1
(43) Pub. Date: May 9, 2019

(54) LENS ASSEMBLY INCLUDING MAGNET ASSEMBLY COMPONENTS FOR MOUNTING ONTO AN EYE GLASS FRAME

(71) Applicant: Interstol Trading Co. Inc., Seattle, WA (US)

(72) Inventor: Anthony Suen, Hong Kong (CN)

(21) Appl. No.: 15/806,968

(22) Filed: Nov. 8, 2017

(51) Int. Cl. G02C 7/08

(52) U.S. Cl. CPC G02C 7/086; G02C 2200/02

(57) ABSTRACT

A lens assembly is described herein that may be configured to removably mount onto to an eye glass frame, and that facilitate the easy and quick removal and replacement of one or more lenses of the lens assembly by end users. The lens assembly may include a lens member that includes at least one lens and at least a first magnet assembly component fixedly coupled to the lens member. The lens assembly may further include a mounting member configured to removably mount onto the eye glass frame, where the mounting member includes at least one attachment arm having a second magnet assembly component, the second magnet assembly component being configured to magnetically mate with the first magnet assembly component, with the at least one attachment arm being attached to a support structure of the mounting member.

### BACKGROUND

### 1. Field of the Invention

The present invention relates to optical accessories, and more particularly to a lens assembly configured to removably mount onto spectacles.

### 2. Description of Related Art

It is well-recognized that the visual or optical needs of a person will vary greatly from person to person depending upon various factors including the age of the person, the specific ophthalmic needs of the person, the occasion or setting, and so forth. For example, a person may have multiple prescription glasses including one for driving, one for reading, and one for viewing screens of computer monitors. In addition, the person may maintain one or more sunglasses for various situations such as for driving, walking, playing sports, etc. In some situations, a person will concurrently need both the functionalities of corrective lens of prescription glasses, and the filtering functionalities of sunglasses. At other times, the person may only need the functionalities of only one type of glasses (e.g., corrective lens). To address these situations various optical solutions have been developed over the years including tinted or light sensitive prescription glasses, and mountable lens assemblies such as flip-up and clip-on sunglasses.

Clip-on sunglasses or simply “clip-ons” have been widely available for many years. Conventional clip-ons typically include a frame with tinted lens disposed within the frame. These clip-ons will be without temples, and instead have components such as grapnels on the frame that are designed to clip and mount onto the frame or lenses of primary glasses such as prescription glasses.

Flip-up sunglasses or simply “flip-ups” have also been commercially available for many years. Conventional flip-ups typically includes a pair of lenses that are pivotably fixed to a mounting structure that is designed to mount onto a pair of glasses.

Although flip-ups and clip-ons have proven to be relatively inexpensive solutions to the multiple needs of eye glass wearers, they are somewhat limited solutions as the lenses of flip-ups as well as clip-ons are normally permanently fixed to the mounting mechanism of these devices and are not easily replaceable. For example, if a user has different filtering and/or corrective lens needs for different occasions, then the user would need to use different clip-ons or flip-ups for different occasions.

### SUMMARY

Various embodiments of the present disclosure provide for a lens assembly that is configured for attachment to an eye glass frame. For the embodiments, the lens assembly may include a lens member including at least one lens and at least a first magnet assembly component fixedly coupled to the lens member, a mounting member configured to removably mount onto the eye glass frame, and wherein the mounting member includes at least one attachment arm having a second magnet assembly component, the second magnet assembly component being configured to magnetically mate with the first magnet assembly component, with the at least one attachment arm being attached to a support structure of the mounting member, whereby the lens member is magnetically attachable to the mounting member.

In some embodiments, the lens assembly may include a clamping component that urges the mounting member toward the eye glass frame when the mounting member is removably mounted on the eye glass frame.

In some embodiments, the at least one attachment arm may have a forwardmost front-side surface facing the lens member when the lens member is attached to the mounting member, and wherein the second magnet assembly component is disposed rearward of the forwardmost front-side surface. In some cases, the at least one attachment arm may have a front-side surface disposed rearward of the forwardmost front-side surface, and the second magnet assembly component may be disposed rearward of the front-side surface or substantially aligned with the front-side surface. In some cases, the attachment arm may include a forwardly opened notch having a forward-facing surface and that is located adjacent to where the second magnet assembly component is coupled to the attachment arm, the forward-facing surface of the notch corresponding to the front-side surface, and a vertical width of the notch that is smaller than a vertical width of the first magnet assembly component of the lens member.

In some embodiments, the at least one attachment arm may have a sidewall surface, and the second magnet assembly component may be disposed at a position such that it is completely laterally offset from the sidewall surface. In some embodiments, the second magnet assembly component may be disposed at a position such that a lateral center of the second magnet assembly may be laterally offset from a lateral center of the at least one attachment arm.

In some embodiments, the at least one attachment arm may be pivotably attached to the support structure. For these embodiments, the least one attachment arm may be a first attachment arm, the mounting member may further include an axle having a first end portion and a second end portion, the first end portion being coupled to the first attachment arm and the second portion being coupled to a second attachment arm having a third magnet assembly component that is configured to magnetically mate with a fourth magnet assembly component of the lens member, and the axle being pivotably coupled to the support structure. In some cases, the lens member may include a first lens and a second lens that is coupled to the first lens via a bridge, the first magnet assembly component being disposed in or on the first lens and the fourth magnet assembly component being disposed in or on the second lens, the first attachment arm includes a first notch and the second attachment arm includes a second notch, the first notch and the second notch being configured to receive a first portion and a second portion of the bridge.

In some embodiments, the lens member may include a first corrective lens and a second corrective lens. In some embodiments, the first magnet assembly component, the second magnet assembly, or both may comprise of one or more magnets. In some embodiments, one of the first magnet assembly component or the second magnet assembly may include ferromagnetic material.

In various embodiments a method is disclosed herein for mounting a lens assembly to an eye glass frame that includes mounting a lens assembly to an eye glass frame, and magnetically attaching a lens member to a contact surface attached to an attachment arm, the attachment arm being coupled to the mounting member, and the contact surface being a surface of a magnet assembly component. In some embodiments, the attachment arm may have a forwardmost surface and the contact surface may be disposed rearward of the forwardmost surface. In some cases, the contact surface may be partially or completely laterally offset from the attachment arm. In some embodiments, the method may further include blocking the lens member from lateral movement by obstructing lateral movement of a magnet assembly component disposed on the lens member using a portion of the attachment arm.

In various embodiments, a lens member is disclosed herein that is configured to magnetically mate with a mounting member that is configured to removably mount onto an eye glass frame. For the embodiments, the lens member may include at least one lens and at least a first magnet assembly component fixedly coupled to the lens member, where the mounting member includes at least one attachment arm having a second magnet assembly component, the first magnet assembly component of the lens member being configured to magnetically mate with the second magnet assembly component of the mounting member. In some embodiments, the first magnet assembly component, the second magnet assembly component, or both the first and second magnet assembly components may include one or more magnets.

### BRIEF DESCRIPTION OF THE DRAWINGS

FIG. 1A is a perspective view of an example mounting member coupled to an eye glass frame and an example lens member that is magnetically attachable to the mounting member.

FIG. 1B is a front view of an example lens assembly mounted on an eye glass frame and comprising of the mounting member and lens member illustrated in FIG. 1A.

FIG. 2A shows front views of the mounting member and the lens member of the lens assembly illustrated in FIG. 1B.

FIG. 2B is a front view of the lens assembly illustrated in FIG. 2A when the lens member and the mounting member illustrated in FIG. 2A are assembled.

FIG. 2C is a close-up view of the magnet assembly components of the lens member illustrated in FIG. 2B magnetically mated with the magnet assembly components of the mounting member.

FIG. 3A is a front view of a mounting member and a lens member of another example lens assembly.

FIG. 3B is a front view of the lens assembly of FIG. 3A when the lens member and the mounting member of FIG. 3A are coupled together.

FIG. 3C is a close-up view of the bridge of the lens member illustrated in FIGS. 3A and 3B.

FIG. 3D is a front view of the mounting member and an outline of the bridge of the lens member illustrated in FIGS. 3A, 3B, and 3C.

FIG. 4A is a rear view of the lens member of FIGS. 3A and 3B.

FIG. 4B is a rear view of the lens member of FIGS. 2A and 2B.

FIG. 5 is a perspective view of the mounting member illustrated in FIGS. 1A, 1B, 2A, 2B, 3A, and 3B.

FIG. 6 is an exploded view of the mounting member of FIG. 5.

FIG. 7 is a close-up view of the attachment assembly illustrated in FIG. 6.

FIG. 8A is a close-up view of the axle, the flat surface of the axel, and the spring of the mounting member of FIG. 6 when attachment arms of the mounting member are in the up position.

FIG. 8B is a close-up view of the axel, the flat surface of the axel, and the spring of the mounting member of FIG. 6 when attachment arms of the mounting member are in the down position.

FIG. 9 a front-side view of another example mounting member according some alternative embodiments.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures and materials of construction have not been described in detail to avoid unnecessarily obscuring the descriptions of the embodiments of the disclosure.

In the present disclosure, to the extent the terms “about,” “approximately,” and “substantially” are used, they mean ±20% of the indicated range, value, or structure, unless otherwise indicated. In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, the terms and variants of which are intended to be construed as non-limiting. The definitions in this paragraph are intended to apply throughout this disclosure unless otherwise expressly stated.

According to various embodiments of the present disclosure, a lens assembly is disclosed that may be configured to removably mount onto to an eye glass frame, and that facilitate the easy and quick removal and replacement of one or more lenses of the lens assembly by end users. In various embodiments, the lens assembly may include a lens member with one or more lenses, a mounting member for removably coupling or mounting the lens assembly to an eye glass frame, and one or more attachment arms that may be pivotably coupled to the mounting member and that the lens member may removably be attach to.

In various embodiments, to facilitate removable attachment of the lens member to the one or more attachment arms, both the lens member and the one or more attachment arms may include corresponding magnet assembly components to magnetically mate the lens member to the one or more attachment arms. Each of the magnet assembly components included in the lens member and the one or more attachment arms may comprise of a magnetic material (e.g., a permanent magnet) and/or ferromagnetic material (e.g., a metal that is attracted to magnets such as iron, nickel, cobalt, etc. that are not permanently magnetized). For example, if the lens member includes at least a first magnet assembly component and the one or more attachment arms include at least a second magnet assembly component that is designed to magnetically mate with the first magnet assembly component, then in some cases, the first magnet assembly component of the lens member may be a magnet while the second magnet assembly component of the one or more attachment arm may be made of a ferromagnetic material.

Alternatively, the first magnet assembly component of the lens member may be made of a ferromagnetic material while the second magnet assembly component of the one or more attachment arms may be a magnet. In other cases, however, both the first magnet assembly component of the lens member and the second magnet assembly component of the one or more attachment arms may comprise of magnets. In these cases, the mating surfaces of the first magnet assembly component and the second magnet assembly component may be of opposite polarity to ensure a strong magnetic attraction between the first and second magnet assembly components.

In some embodiments, to ensure that the lens member is secure to the one or more attachment arms, the one or more attachments arms may include features that may restrict the movement of the lens member once the lens member has mated with the one or more attachment arms. As will be further described herein, in some cases, this may involve placing a magnet assembly component of an attachment arm in a rearward and lateral offset position relative to the attachment arm. In some cases, in order to further secure the lens member to the attachment arm, the attachment arm may further include a notch located adjacent to where the magnet assembly component is attached to the attachment arm as will be further described herein.

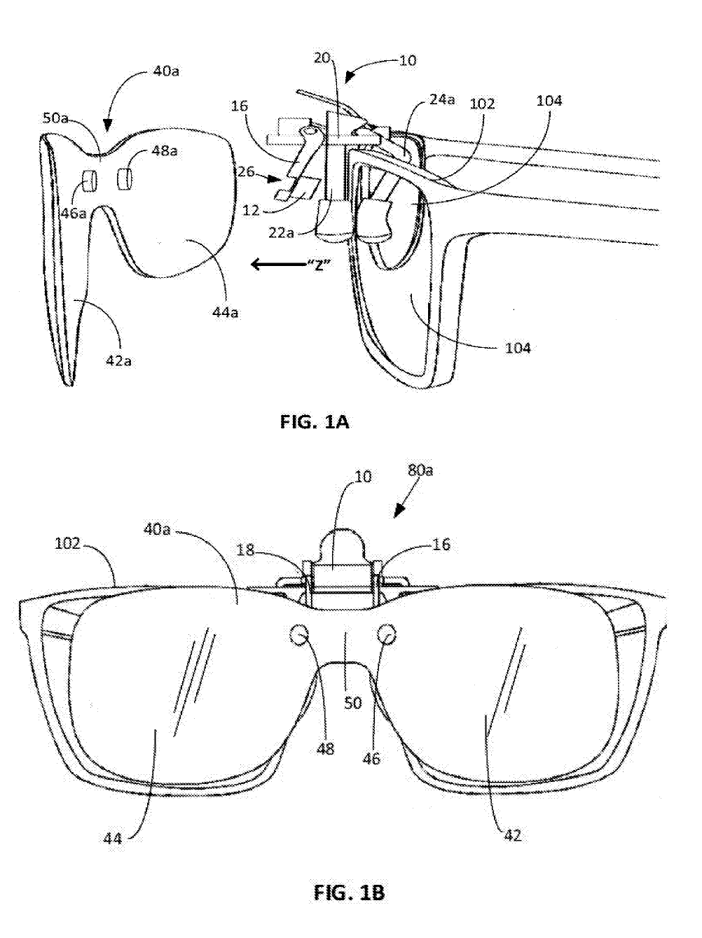

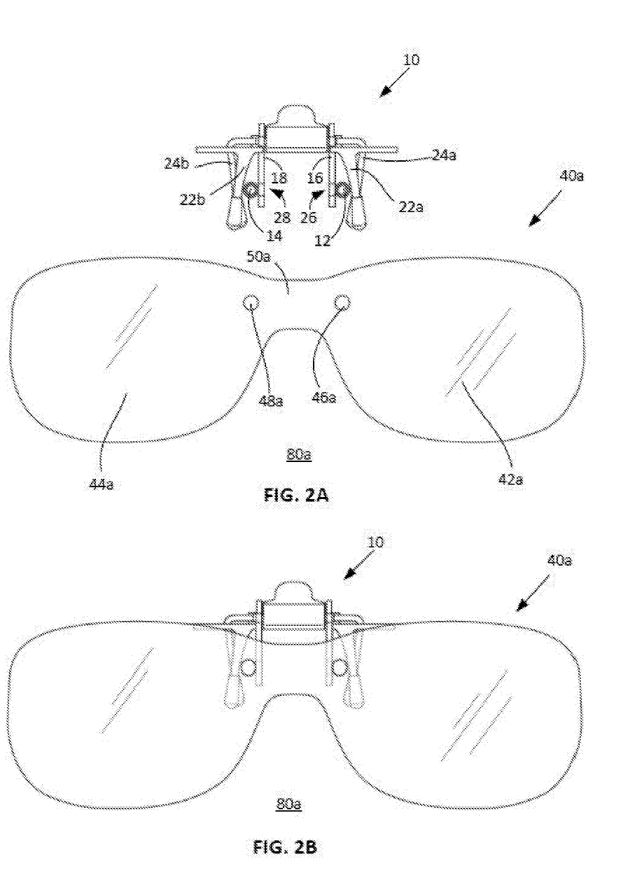

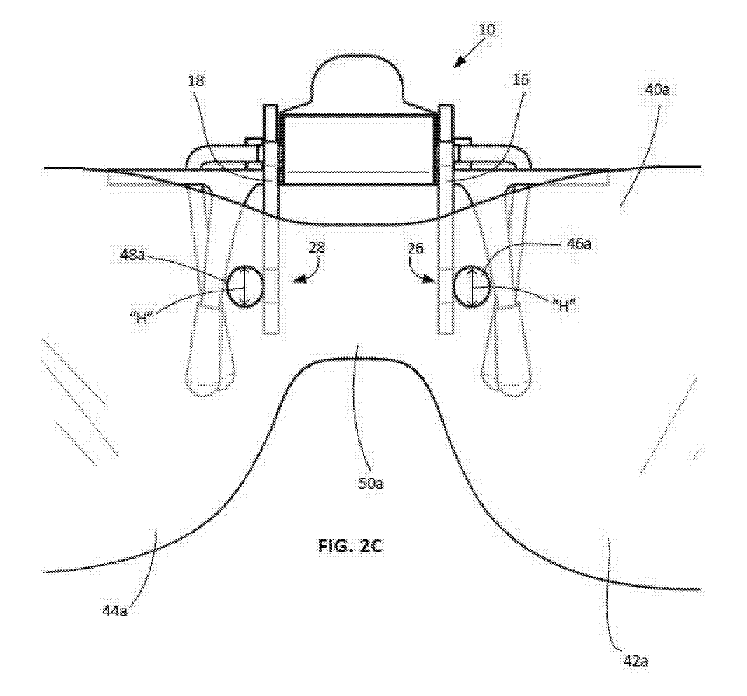

FIG. 1A is a perspective view of an example mounting member 10 mounted onto an eye glass frame and an example lens member 40a that may be magnetically attached to the mounting member 10 according to various embodiments. In the embodiment illustrated in FIG. 1A, the mounting member 10 is mounted onto an eye glass frame 102. The combination of the mounting member 10 and the lens member 40a will be referred to herein as a lens assembly 80a as illustrated, for example, in FIGS. 2A and 2B. In various embodiments, lens member 40a may include two lens portions 42a and 44a that are coupled together via a bridge 50a, and a pair of magnet assembly components 46a and 48a disposed on or in the two lens portions 42a and 44a and proximate to the bridge 50a. In alternative embodiments, the pair of magnet assembly components 46a and 48a may be located on or in the bridge 50a. The pair of magnet assembly components 46a and 48a may be configured to magnetically mate with corresponding magnet assembly components 12 and 14 (see FIG. 2A) of the mounting member 10.

The mounting member 10 may include a first and second attachment arms 16 and 18 (see FIG. 2A). Each of the attachment arms 16 and 18 of mounting member 10 may include a corresponding magnet assembly component 12 and 14. As illustrated in FIGS. 1A and 2A, the magnet assembly component 12 may be positioned rearwardly and laterally offset from the attachment arm 16. Note that in the following description, words such as “front,” “forward,” “forwardmost,” “inwards,” “rearwards,” “rearwardly,” and the like are used herein in reference or relative to the direction in which a user wears and looks through the lens assembly 80a when the lens assembly 80a is mounted onto the eye glass frame 102. For example, the user's line of sight will generally parallel direction “Z” as illustrated in FIG. 1A. Thus, in FIG. 1A the lens member 40a is illustrated as being disposed on the forward or front side of the eye glass frame 102.

The attachment arm 16 is pivotably attached to a support structure 20 of the mounting member 10. In the embodiment illustrated in FIGS. 1A, 1B, 2A, and 2B the attachment arm 16 is in a substantially “down” position, (e.g., when attachment arms 16 and 18 are in the down position, a lens member 40a that is magnetically coupled to the attachment arms 16 and 18 will cover the lenses 104 of the eye glass frame 102). The mounting member 10, as further illustrated in FIGS. 1A, 1B, 2A, and 2B, includes at least a first pair of opposing prongs 22a and 24a and a second pair of opposing prongs 22b and 24b. In various embodiments, the end section of the prong 24a is biased towards the end section of prong 22a. Similarly, the end section of prong 24b is biased towards the end section of prong 22b. As a result, when a portion of the eye glass frame 102 is inserted between prongs 22a and 24a, and prongs 22b and 24b, prongs 24a and 24b will urge the portion of the eye glass frame 102 towards prongs 22a and 22b.

FIG. 1B is a front view of the lens assembly 80a mounted onto the eye glass frame 102. The lens assembly 80a includes the mounting member 10 and lens member 40a illustrated in FIG. 1A. In some embodiments, the two lens portions 42a and 44a and the bridge 50a may be made from a single unitary material such as plastic.

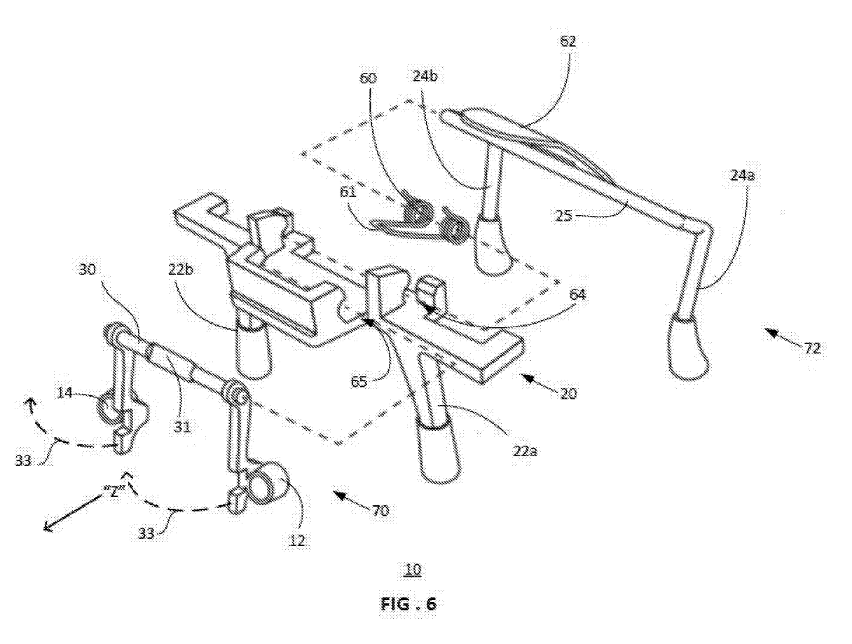

FIG. 2A shows separately the front views of the mounting member 10 and the lens member 40a of lens assembly 80a of FIGS.1B. The mounting member 10 may include an attachment arm 16 with magnet assembly component 12, and an attachment arm 18 with magnet assembly component 14. As will be further described herein, the attachment arms 16 and 18 in some embodiments may be pivotably attached to a support structure 20 (see FIG. 6) of the mounting member 10. In the embodiment illustrated in FIG. 2A, the two magnet assembly components 12 and 14 are rearwardly and laterally off-set from their respective attachment arms 16 and 18. Disposed in the attachment arms 16 and 18 adjacent to where the two magnet assembly components 12 and 14 are attached to the two attachment arms 16 and 18 are notches 26 and 28 (see FIG. 5 for perspective views of notches 26 and 28).

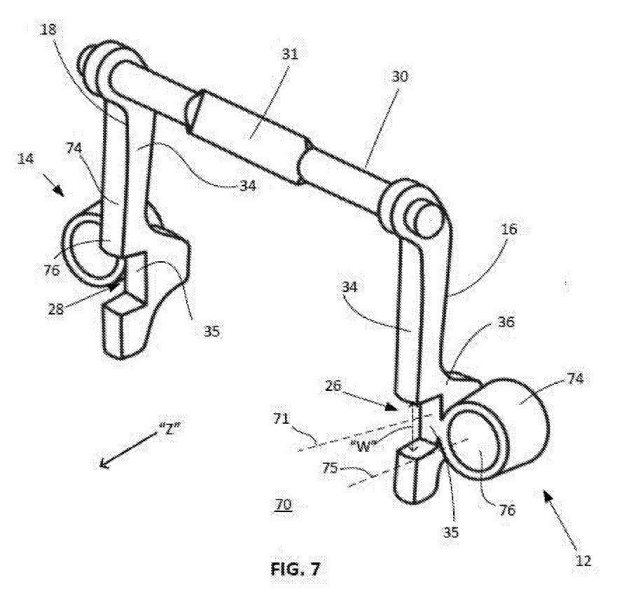

In various embodiments, and as will be described in greater detail herein, the combination of the rearward and lateral off-set positions of the magnet assembly component 12 and 14 relative to the attachment arms 16 and 18 (see the magnet assembly component 12 relative to the attachment arm 16 in FIG. 1A), the presence of the notches 26 and 28 in attachment arms 16 and 18, and the presence of sidewall surfaces 36 (see FIG. 7) of the attachment arms 16 and 18 may ensure that the lens member 40a is at least laterally secured to the mounting member 10 when the magnet assembly components 46a and 48a of the lens member 40a have been magnetically mated to magnet assembly components 12 and 14 of the mounting member 10.

As alluded to earlier, the mounting member 10 may include a first pair of opposing prongs 22a and 24a, and a second pair of opposing prongs 22b and 24b that form at least a part of a clamping mechanism designed to clamp or mount the mounting member 10 to an eye glass frame 102. In various embodiments, prongs 22a and 22b may be biased towards their opposing prongs 24a and 24b via a biasing means such as a spring 60 (see FIGS. 5 and 6) as will be further illustrated herein. As a result, the mounting member 10 may be removably secured to an eye glass frame 102 by inserting a portion of the eye glass frame 102 between the pairs of opposing prongs (e.g., prongs 22a and 24a and prongs 22b and 24b). Note that in alternative embodiments other types of mounting or clamping mechanisms/assemblies may be employed to clamp the mounting member 10 onto an eye glass frame 102.

In various embodiments, magnet assembly component 12 of mounting member 10 may be configured to magnetically mate with magnet assembly component 46a of lens member 40a while magnet assembly component 14 may be configured to magnetically mate with magnet assembly component 48a of lens member 40a. Thus, magnet assembly component 12 and magnet assembly component 46a may form a magnetic pair. In some embodiments, to form a magnetic pair, at least one of the magnet assembly component 12 or the magnet assembly component 46a is made from a magnetic material (e.g., a permanent magnet) while the other may be formed from ferromagnetic material (e.g., a metal that is attracted to magnets such as iron, nickel, cobalt, etc., and that is not permanently magnetized). Alternatively, both of the magnet assembly components 12 and 46a may be formed from magnets, where the mating surfaces of the magnet assembly component 12 and the magnet assembly component 46a are of opposite polarity. This may ensure that the magnetic attraction between magnet assembly component 12 and magnet assembly component 46a is relatively strong.

Similarly, magnet assembly component 14 of the mounting member 10 may be configured to magnetically mate with magnet assembly component 48a of lens member 40a where one or both of the magnet assembly component 14 and the magnet assembly component 46a may be formed with magnets. FIG. 2B is a front view of the lens assembly 80a of FIG. 2A when the lens member 40a is coupled to the mounting member 10.

FIG. 2C is a close-up view of the magnet assembly components 46a and 48a of the lens member 40a magnetically mated with the magnet assembly components 12 and 14 of the mounting member 10. In various embodiments, the notches 26 and 28 of attachment arms 16 and 18 may have vertical widths (see vertical width “W” of FIG. 7) that are smaller than the vertical widths of the magnet assembly components 46a and 48a of lens member 40a. The smaller vertical widths of the notches 26 and 28 relative to the magnet assembly components 46a and 48a of the lens member 40a may ensure that only portions of the magnet assembly components 46a and 48a will enter the notches 26 and 28 when lateral pressure (e.g., left to right or right to left in FIG. 2C) is applied to the lens member 40a. As a result, the lens member 40a is prevented from substantially moving laterally (e.g., in the left and right directions in FIG. 2C), as well as to a lesser extent vertically (e.g., up and down directions in FIG. 2C), when the lens member 40a is magnetically mated with the mounting member 10.

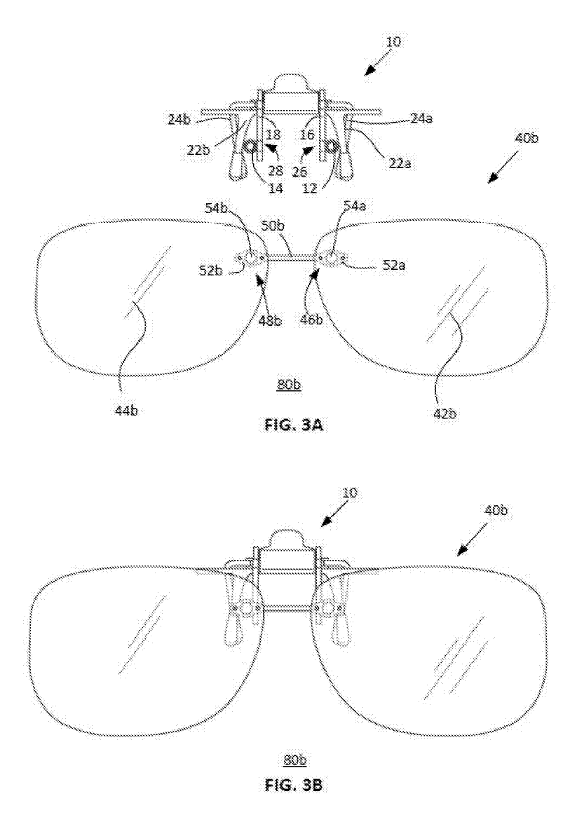

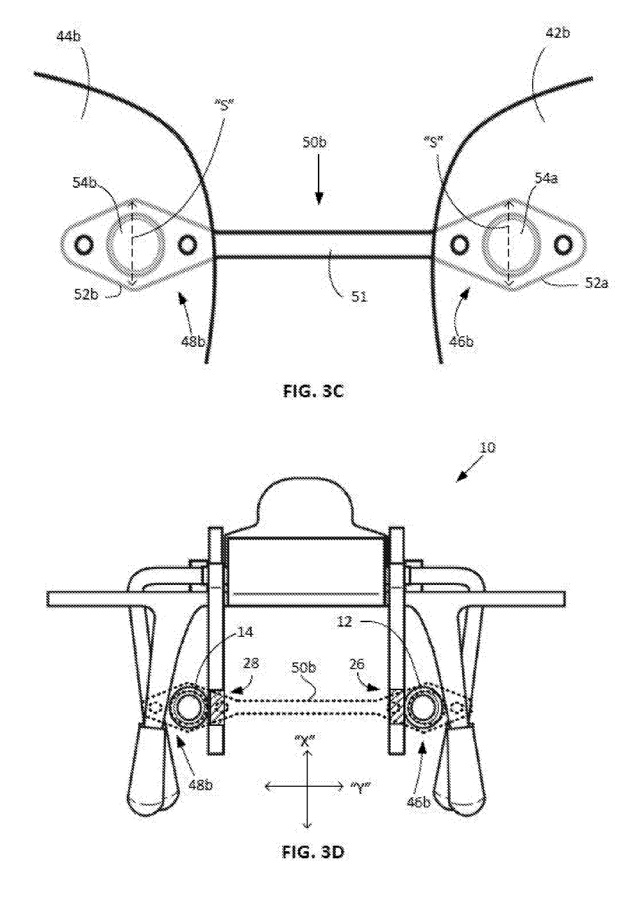

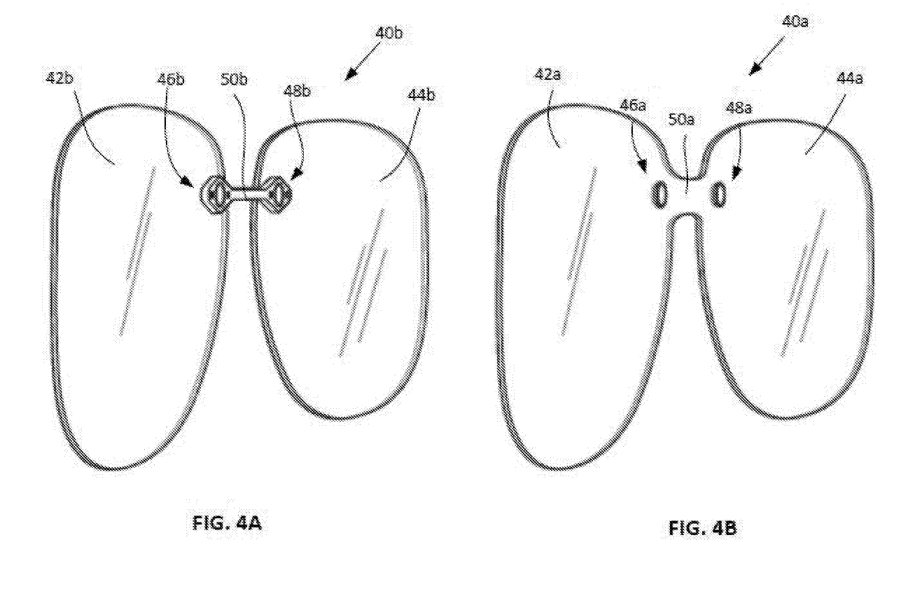

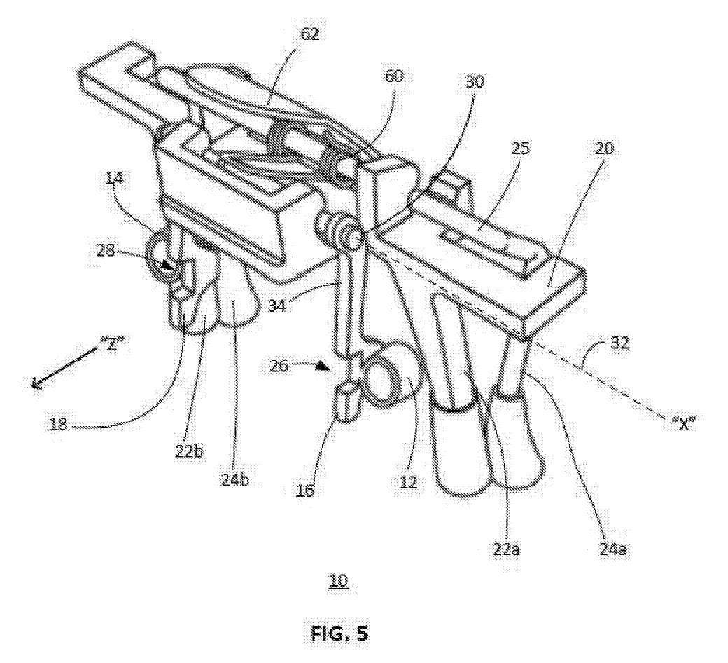

Turning to FIG. 3A which is a front view of another example lens assembly 80b according to some embodiments. For these embodiments, the lens assembly 80b may include the previously described mounting member 10, and a lens member 40b. As illustrated, the lens member 40b may include lens portions 42b and 44b, which in this case are individual lenses and that are coupled together via a bridge 50b. In some embodiments, lens portions 42b and 44b may be corrective lenses (e.g., lenses for treating myopia, hyperopia, astigmatism, and presbyopia) and/or sunglass lenses (e.g., polarized lenses, blue-blockers, mirror-coated lenses, gradient lenses, photochromic lenses, and so forth). According to some embodiments, the bridge 50b may be disposed on the rear-side rather than the front-side of lens member 40b as illustrated in FIG. 4A. That is, the bridge 50b may be disposed on the side of the lens member 40b that will face an end user when the end user is wearing the eye glass frame 102 that the lens member 40b is mounted to.

The end portions of the bridge 50b may be fixed to lens portion 42b and lens portion 44b by screws, cement, or by other means. In various embodiments, the end portions of bridge 50b may comprise of magnetic component receivers 52a and 52b. Disposed within magnetic component receiver 52a and magnetic component receiver 52b are magnetic components 54a and 54b, respectively. In various embodiments, magnetic components 54a and 54b may comprise of a magnet or ferromagnetic material. In the embodiment illustrated in FIG. 3A, magnetic component receiver 52a and magnetic component 54a combine to make up the magnet assembly component 46b while magnetic component receiver 52b and magnetic component 54b combine to make up the magnet assembly component 48b. In some embodiments, bridge 50b may be made from a metal or metal alloy, such as steel, or other materials such as ceramic or plastic.

FIG. 3B is a front view of the lens assembly 80b of FIG. 3A when the lens member 40b is coupled to the mounting member 10. Note that when the lens member 40b is magnetically attached to the mounting member 10, portions of the bridge 50b will sit in notches 26 and 28 (see, for example, FIG. 3D), which may ensure that the lens member 40b is vertically and laterally secured (e.g., secured from moving up/down and left/right in FIG. 3B) to the mounting member 10.

FIG. 3C is a close-up view of bridge 50b of the lens member 40b of FIGS. 3A and 3B viewed from the front-side of the lens member 40b. As illustrated, bridge 50b may comprise of an elongated piece 51. Disposed at the ends of the elongate piece 51 are magnetic component receivers 52a and 52b. Disposed within the magnetic component receivers 52a and 52b are magnetic components 54a and 54b. In various embodiments, the magnetic components 54a and 54b may comprise of magnets and/or ferromagnetic material (e.g., a non-magnet material). In various embodiments, the magnet assembly components 46b and 48b may each have a vertical width of “S” (similarly, the magnet assembly components 46a and 48a of FIGS. 2A and 2B of lens member 40a may also have a vertical width). In the embodiment illustrated in FIG. 3C, magnetic component receivers 52a and 52b may be attached to lens portions 42b and 44b via screws. In alternative embodiments, the magnetic component receivers 52a and 52b may be attached to the lens portions 42b and 44b by other means such as via glue or cement.

FIG. 3D is a front view of the mounting member 10 and an outline of the bridge 50b of the lens member 40b of FIGS. 3A, 3B, and 3C in isolation when the lens member 40b is magnetically mated to the mounting member 10. More particularly, FIG. 3D shows portions of the bridge 50b being inserted into notches 26 and 28 when the magnet assembly components 46b and 48b of the lens member 40b are magnetically mated to the magnet assembly components 12 and 14 of the mounting member 10. In various embodiments, the vertical width “W” (see, for example, FIG. 7) of notches 26 and 28 are smaller than the vertical width “S” (see, for example, FIG. 3C) of magnet assembly components 46b and 48b of lens member 40b. As a result, when the lens member 40b is magnetically coupled to the mounting member 10, the lens member 40b may be vertically as well as laterally secured to the mounting member 10. That is, when the bridge 50b of the lens member 40b is magnetically coupled to the mounting member 19, the lens member 40b that the bridge 50b is part of may be prevented from moving along the “Y” axis (e.g., laterally) as well as along the “X” axis (e.g., vertically).

FIG. 4A is a rear view of the lens member 40b of FIGS. 3A and 3B. In various embodiments, the bridge 50b may be disposed on the side of the lens member 40b that will face an end user when the lens member 40b is attached to an eye glass frame 102 that is being worn by the end user. In contrast, FIG. 4B is a rear view of lens member 40a of FIGS. 2A and 2B. In various embodiments, the magnet assembly components 46b and 48b of lens member 40b may protrude rearward from the read sides of lens portions 42b and 44b. In some cases, such a configuration may ensure that the magnet assembly components 46b and 48b will have good contact with magnetic assembly components 12 and 14 of the mounting member 10 when the lens member 40b is magnetically mated with the mounting member 10. Similarly, the magnet assembly components 46a and 48a of lens member 40a of FIG. 4B may also protrude rearward from the rear sides of lens portions 42a and 44a.

FIG. 5 is a perspective view of the mounting member 10 illustrated in FIGS. 1A, 1B, 2A, 2B, 3A, and 3B. In various embodiments, attachment arms 16 and 18 may be coupled to axle 30 that is pivotably coupled to support structure 20. More particularly, axle 30 may define axis “X,” which axle 30 can pivot around. In some alternative embodiments, however, attachment arms 16 and 18 may not be pivotably coupled to the support structure 20) but instead may be fixed to the support structure 20. In such embodiments, the attachment arms 16 and 18 may be fixed in the “down” position rather than in an “up” position.

As alluded to earlier, the mounting member 10 includes a clamping mechanism for clamping or mounting the mounting member 10 to an eye glass frame 102 that includes a first pair of opposing prongs 22a and 24a and a second pair of opposing prongs 22b and 24b. Note that although the mounting member 10 is illustrated as employing a particular type of clamping or mounting mechanism that employs pairs of opposing prongs, one of ordinary skill in the relevant art will recognize that other types of clamping or mounting mechanism may be employed in alternative embodiments to mount the mounting member 10 to an eye glass frame 102.

In various embodiments, prongs 22a and 22b may be part of the support structure 20. In contrast, prongs 24a and 24b may be coupled to lateral bar 25, which is pivotably mounted to support structure 20. Lateral bar 25 may be inserted through the coil sections of a spring 60, which biases at least the end portions of prongs 24a and 24b towards the end portions of prongs 22a and 22b. Attached to lateral bar 25 is lever 62 that an end user may press down to urge prongs 24a and 24b away from opposing prongs 22a and 22b.

Turning to FIG. 6, which is an exploded view of the mounting member 10 of FIG. 5. In various embodiments, the mounting member 10 may include three functional structures including an attachment assembly 70, a support structure 20, and a clamping assembly 72. As illustrated, the attachment assembly 70 may be designed to magnetically mate with a lens member 40a or 40b and may include, among other things, a pair of attachment arms 16 and 18 that are coupled together via axle 30. The axle 30 may include a flat surface 31 that may permit at least portions of the attachment assembly 70 (e.g., attachment arms 16 and 18) to stay in an “up” position when, for example, a lens member 40a or 40b is magnetically attached to the attachment arms 16 and 18 and is being worn by an end user and the end user elects not to use the lens member 40a or 40b. In some alternative embodiments, the attachment assembly 70 may include fewer or more attachment arms 16 and 18 than the two illustrated in FIG. 6. For example, in some embodiments, the attachment assembly 70 may comprise of a single attachment arm that is elongated or generally flat and that may include one or more magnet assembly components 12 and 14.

In various embodiments, support structure 20 includes, among other things, prongs 22a and 22b, and groves 64 and 65. Groove 64 may be configured to receive lateral bar 25 of the clamping assembly 72 while groove 65 may be configured to receive axle 30 of the attachment assembly 70.

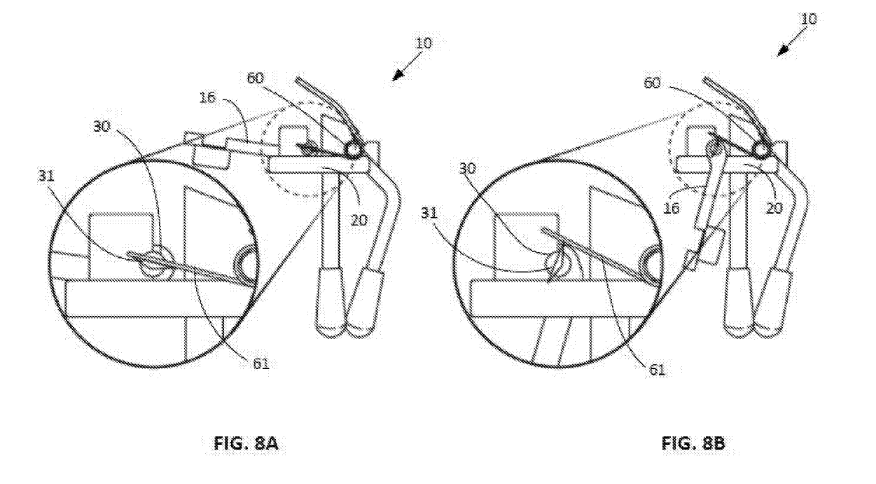

The clamping assembly 72 includes, among other things, prongs 24a and 24b that are coupled together via lateral bar 25, and spring 60 that has a U-section 61. When the attachment assembly 70, the support structure 20, and the clamping assembly 72 have been combined to form the mounting member 10, the U-section 61 of spring 60 may be biased against the portion of the axle 30 that includes the flat surface 31. As a result, when attachment arms 12 and 14 are pivoted or rotated to the “up” position, the flat surface 31 will rotate until it is held in place by the U-section 61 of spring 60 as illustrated by FIG. 8A. For example, if a lens member 40a or 40b is magnetically coupled to attachment arms 12 an 14 of the mounting member 10, and the mounting member 10 is mounted onto an eye glass frame 102 that is being worn by an end user, the end user may “flip open” the lens member 40a or 40b by pushing or pulling up one of the attachment arms 12 or 14 until the flat surface 31 of axle 30 settles against the U-section 61, which causes the lens member 40a to be “snapped” into the open or up position as illustrated by ref. 33 in FIG. 6.

FIG. 7 is a close-up view of the attachment assembly 70 illustrated in FIG. 6. As shown, attachment assembly 70 may include a pair of attachment arms 16 and 18 that are coupled together via an axle 30. Attached to attachment arms 16 and 18 are magnet assembly components 12 and 14, respectively. As illustrated, attachment arms 16 and 18 may include notches 26 and 28 that are located adjacent to where the magnet assembly components 12 and 14 are attached to the attachment arms 16 and 18. The attachment arms 16 and 18 may each have a top forwardmost front-side surface 34, an exterior sidewall 36, and a front-side surface 35 disposed at the bottom of notches 26 and 28.

In various embodiments, the magnet assembly components 12 and 14 may be positioned or disposed rearward relative to the forwardmost front-side surfaces 34 of their corresponding attachment arms 16 and 18. In some embodiments, the magnet assembly components 12 and 14 may be partially or completely laterally offset from the exterior sidewalls 36 of their respective attachment arms 16 and 18. For example, in some embodiments, the magnet assembly component 12 may have a lateral center 75 while the attachment arm 16 may also a have lateral center 71. For these embodiments, the lateral center 75 of the magnet assembly component 12 may be laterally offset from the lateral center 71 of the attachment arm 16.

In various embodiments, the vertical width “W” of notch 26 may be smaller than the vertical width (see, for example, vertical width “H” in FIG. 2C and vertical width “S” in FIG. 3C) of a corresponding magnet assembly component 46a or 46b of lens member 40a or 40b. Similarly, the vertical width of notch 28 may be smaller than the vertical width of a corresponding magnet assembly component 48a or 48b of lens member 40a or 40b.

In various embodiments, the magnet assembly component 12 may include a magnetic component receiver 74 that is coupled to the attachment arm 16. The magnetic component receiver 74 may be configured to receive a magnetic component 76, which may be a magnet or a ferromagnetic material. In some embodiments, the magnet assembly component 12 may not include the magnetic component receiver 74 in which case the magnetic component 76 may be directly attached to the attachment arm. In various embodiments, attachment arm 18 may include the same or similar features (e.g., magnet assembly component 12, magnetic component receiver 74, magnetic component 76, and so forth) as those described above with respect to attachment arm 16.

FIGS. 8A and 8B are close-up views of the axle 30, flat surface 31 of the axle 30, and U-section 61 of spring 60 when the attachment arm 16 is in the “up” and “down” position. More particularly, FIG. 8A shows U-section 61 of the spring 60 lying flat against the flat surface 31 when the attachment arm 16 is in the up position. In contrast, when the attachment arm 16 is in the down position, the flat surface 31 may be substantially perpendicular to the U-section 61.

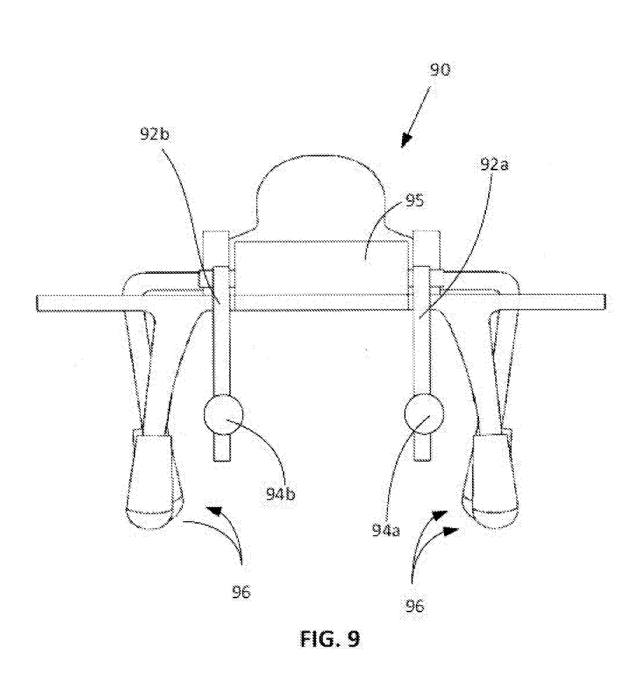

FIG. 9 illustrates another example mounting member 90 according to some alternative embodiments Like the mounting member 10 previously illustrated, mounting member 90 includes prongs 96, support structure 95, a pair of attachment arms 92a and 92b, and a pair of magnet assembly components 94a and 94b. However, unlike mounting member 10, mounting member 90 includes magnet assembly components 94a and 94b that are disposed on top of attachment arms 92a and 92b rather than offset (either lateral offset or rearwardly offset) from the attachment arms 92a and 92b.

The various embodiments described herein, are presented as non-limiting example embodiments of the present disclosure, unless otherwise expressly indicated. After reviewing the present disclosure, an individual of ordinary skill in the art will immediately appreciate that some details and features can be added, removed and/or changed without deviating from the spirit of the disclosure. Reference throughout this specification to “various embodiments,” “one embodiment,” “an embodiment,” “additional embodiment(s)”, “alternative embodiments,” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

What is claimed is:

1. A lens assembly configured for attachment to an eye glass frame, comprising:
a lens member including at least one lens and at least a first magnet assembly component fixedly coupled to the lens member;
a mounting member configured to removably mount onto the eye glass frame; and
wherein the mounting member includes at least one attachment arm having a second magnet assembly component, the second magnet assembly component being configured to magnetically mate with the first magnet assembly component, with the at least one attachment arm being attached to a support structure of the mounting member, whereby the lens member is magnetically attachable to the mounting member.

2. The lens assembly of claim 1, wherein the mounting member includes a clamping component that urges the mounting member toward the eye glass frame when the mounting member is removably mounted on the eye glass frame.

3. The lens assembly of claim 1, wherein the at least one attachment arm has a forwardmost front-side surface facing the lens member when the lens member is attached to the mounting member, and wherein the second magnet assembly component is disposed rearward of the forwardmost front-side surface.

4. The lens assembly of claim 3, wherein the at least one attachment arm has a front-side surface disposed rearward of the forwardmost front-side surface, and wherein the second magnet assembly component is disposed rearward of the front-side surface or substantially aligned with the front-side surface.

5. The lens assembly of claim 4, wherein the attachment arm includes a forwardly opened notch having a forward-facing surface and that is located adjacent to where the second magnet assembly component is coupled to the attachment arm, the forward-facing surface of the notch corresponding to the front-side surface, and a vertical width of the notch being smaller than a vertical width of the first magnet assembly component of the lens member.

6. The lens assembly of claim 3, wherein the at least one attachment arm has a sidewall surface, and wherein the second magnet assembly component is disposed at a position such that it is completely laterally offset from the sidewall surface.

7. The lens assembly of claim 3 wherein the second magnet assembly component is disposed at a position such that a lateral center of the second magnet assembly is laterally offset from a lateral center of the at least one attachment arm.

8. The lens assembly of claim 1, wherein the at least one attachment arm is pivotably attached to the support structure.

9. The lens assembly of claim 8, wherein the at least one attachment arm is a first attachment arm, the mounting member further includes an axle having a first end portion and a second end portion, the first end portion being coupled to the first attachment arm and the second portion being coupled to a second attachment arm having a third magnet assembly component that is configured to magnetically mate with a fourth magnet assembly component of the lens member, and the axle being pivotably coupled to the support structure.

10. The lens assembly of claim 9, wherein the lens member includes a first lens and a second lens that is coupled to the first lens via a bridge, the first magnet assembly component being disposed in or on the first lens and the fourth magnet assembly component being disposed in or on the second lens, the first attachment arm includes a first notch and the second attachment arm includes a second notch, the first notch and the second notch being configured to receive a first portion and a second portion of the bridge.

11. The lens assembly of claim 1, wherein the lens member includes a first corrective lens and a second corrective lens.

12. The lens assembly of claim 1, wherein the first magnet assembly component, the second magnet assembly, or both comprises one or more magnets.

13. The lens assembly of claim 1 wherein one of the first magnet assembly component or the second magnet assembly includes ferromagnetic material.

14. A mounting assembly configured to removably mount onto an eye glass frame comprising:
a support structure; and
one or more attachment arms that are pivotably coupled to the support structure, each of the one or more attachment arms having a corresponding magnet assembly component that is configured to magnetically mate with one or more magnet assembly components of a lens member.

15. The flip-up mounting assembly of claim 14, wherein the one or more attachment arms include a first attachment arm and a second attachment arm that are coupled together via an axle, the axle being pivotably coupled to the support structure and defining an axis that the axle is pivotable around, and the first and second attachment arms extending away from the axis.

16. The flip-up mounting assembly of claim 15, wherein each of the first and second attachment arms having forwardmost front-side surfaces that faces the lens member when the lens member is magnetically coupled to the mounting assembly, and each of the corresponding magnet assembly components of the first and second attachment arms are disposed rearward of the forwardmost fronts-side surfaces of the first and second attachment arms.

17. A method of mounting a lens assembly to an eye glass frame comprising:
removably attaching a mounting member to the eye glass frame; and
magnetically attaching a lens member to a contact surface attached to an attachment arm, the attachment arm being coupled to the mounting member, and the contact surface being a surface of a magnet assembly component.

18. The method of claim 17 wherein the attachment arm has a forwardmost surface and the contact surface is disposed rearward of the forwardmost surface.

19. The method of claim 18 wherein the contact surface is partially or completely laterally offset from the attachment arm.

20. The method of claim 18 further comprising blocking the lens member from lateral movement by obstructing lateral movement of a magnet assembly component disposed on the lens member using a portion of the attachment arm.
